(19) United States
(12) Patent Application Publication
(10) Pub. No.: US 2012/0060465 A1
(43) Pub. Date: Mar. 15, 2012

(54) DEVICE FOR SPRAYING A FLUID USING THE AIR BLAST EFFECT

(76) Inventor: Bernard Etcheparre, Anglet (FR)

(21) Appl. No.: 13/256,062

(22) PCT Filed: Mar. 9, 2010
(86) PCT No.: PCT/FR2010/050401

§ 371 Date: Nov. 15, 2011

(30) Foreign Application Priority Data
Mar. 13, 2009 (FR) 0901164

(51) Int. Cl. F02K 3/02; B05B 7/26

(52) U.S. Cl. 60/226.1; 239/337; 239/8

(57) ABSTRACT

A device making it possible to better spray the fluid that one wishes to spray by using a portion of the air blast which is intended to diffuse it. The device has a low pressure airflow generator, supplied with ambient air, capable of creating a high-flow-rate compressed air blast in an aerodynamic stream, and a pre-mixing chamber, supplied with compressed air by tapping a portion of the flow at the outlet of the stream using nozzles, provided with aerodynamic swirlers of which the effect are known, supplement the spraying of the fluid carried out by pressurized ejectors.

### CROSS-REFERENCE TO RELATED APPLICATIONS

This application is a U.S. National Stage Application of International Application No. PCT/FR2010/050401 filed Mar. 9, 2010, which designates the United States of America, and claims priority to French Application No. 0901164 filed Mar. 13, 2009, the contents of which are hereby incorporated by reference in their entirety.

### TECHNICAL FIELD

This invention relates to a device intended to improve the spraying capacity of different fluids and in particular of water, using the air blast effect, for applications intended primarily for the field of civil protection, but also for the protection of the environment and of agriculture.

The need to spray different fluids and in particular water, in more or less large quantities, in more or less fine droplets at more or less substantial distances, by using the blast of a column of air, can be found in different applications. In particular in fire fighting application by the effect of the atomization in order to extinguish the fire but also in order to protect or cool, in applications for protecting the environment for protection or decontamination actions or very simply in agricultural applications for wetting or the spreading of phytosanitary products.

### BACKGROUND

In all cases, the technique is first based on the idea of spraying the fluid through one or more injectors arranged generally in a crown and placed at the periphery and in the airflow created by a more or less powerful fan, in such a way that the droplets that result from this are sufficiently fine to be mixed with the air blast that is carrying them.

In order to spray the fluid in more or less fine droplets, the techniques generally used are hydro-mechanical techniques and in order to create the air blast, the principle generally used, is that of ducted fans which create more or less substantial airflows in conditions of very low pressure.

The technique of spraying the fluid, generally retained, is based primarily on the effect of mechanical fracturing which is created on the ejector by the effect of the pressure that is exerted at the inlet of the ejector on the fluid and which also depends on the geometry of the streaming hole. The higher the flow rate, the more effort is consequently needed to provide for the passage. This results in needs in terms of motorization power of the pumps and difficulties in guaranteeing the proper operation at substantial pressures for substantial flows.

The technique of mixing the air and the fluid is generally of the most trivial and consists in distributing as best as possible the spray injectors of the fluid at the periphery of the hull in the ejected airflow in such a way as to harmonize the flow of the fluid ejected and primarily allow this airflow to provide this function of mixing.

### SUMMARY

According to various embodiments:

Firstly, the spraying conditions can be improved in such a way as to obtain a fracturing of the fluid into droplets that are sufficiently fine with a lesser need of hydraulic power.

Secondly, an air/fluid pre-mixture can be created which tends to favor a final mixture that is much more intimate with the column of air which carries the fluid.

According to an embodiment, a device for spraying a fluid using an air blast effect arranged on a high-rate compressed air flow generator, supplied with ambient air and comprising a blower driven by an engine or a turboshaft engine integrated into a central body supplied with primary compressed air, fixed or mobile flow straighteners placed downstream of the blower, a fairing creating an aerodynamic stream of secondary compressed air around the central body, may comprise one or several pre-mixing chambers receiving the fluid to be sprayed, via a supply in fluid, spraying and pre-mixing this fluid before diffusing it through cones using the air blast effect, wherein the device comprises at least one nozzle for tapping compressed air connected to the stream of secondary air.

According to a further embodiment, the supply in fluid to be sprayed can be connected to a source of a fluid intended for civil protection, the protection or the decontamination of the environment, or for agriculture. According to a further embodiment, the device for spraying a fluid and the airflow generator can be designed and dimensioned in such a way that the flow of secondary compressed air, created in the aerodynamic stream by the rotation of the blower, is in overpressure in relation to the outside ambient air by at least 15% in nominal operation. According to a further embodiment of the device, it may comprise several nozzles for tapping air arranged in the flow of the aerodynamic stream of secondary compressed air, at the outlet of this stream, in such a way that the pre-mixing chamber or chambers are supplied with secondary compressed air at a pressure that is at least greater by 15% than the outside ambient air. According to a further embodiment of the device, each pre-mixing chamber can be provided with a supply conduit of the fluid to be sprayed of which the outlet orifice carries an ejector, which exits into an aerodynamic swirler arranged at the bottom of the chamber of which the function is to supplement the spraying of the ejector by aerodynamic shearing and to provide an air/fluid pre-mixture before ejecting it into the free air, in the blast of air. According to a further embodiment of the device, the pre-mixture can be ejected after a venturi which exits into the free air in the blast of air. According to a further embodiment of the device, it may comprise two annular conduits with directed slots receiving the secondary air, one causing to rotate a portion of this air in one direction, around the fluid sprayed, the other causing to rotate the rest of the air in the other direction around the venturi. According to a further embodiment of the device, it may comprise several ejection cones in the secondary residual airflow of several pre-mixing chambers. According to a further embodiment of the device, it may comprise several nozzles for tapping of several pre-mixing chamber arranged, in the secondary airflow, straight and at the outlet of the stream, in such a way that they do not hinder the ejection of the residual secondary flow, which can represent up to 80% of the total of the flux of secondary air, and which constitutes, once ejected into the free air, the air blast which dilutes and which diffuses the droplets of the fluid diffused.

According to another embodiment, an engine may comprise a stream of secondary air around a stream of primary air, wherein the engine comprises the device for spraying a fluid as described above, by constituting said high-rate compressed air flow generator at the stream of secondary air to which is/are connected the nozzle or nozzles for tapping compressed air.

According to a further embodiment of the engine, it relates to a turbofan engine. According to a further embodiment of the engine, the device for spraying a fluid may comprise one or several satellites enclosing said pre-mixing chamber or chambers and arranged around the fairing of the stream of secondary air.

According to yet another embodiment, a turbofan engine supplied with ambient air and comprising a stream of secondary compressed air located around a central body supplied with primary compressed air and a blower driven by an engine or a turboshaft engine integrated into said central body, may comprise a device for spraying a fluid to be sprayed using the air blast effect, the device being provided with one or several pre-mixing chambers comprising a compressed air tapping nozzle connected to said stream of secondary air and supplied with said fluid to be sprayed in such a way as to spray and pre-mix this fluid with the tapped compressed air, before distributing the mixture to the exterior, through ejection cones, using the air blast effect created.

According to yet another embodiment, in a method for spraying a fluid, wherein this fluid is mixed with compressed air, before diffusing the mixture using the air blast effect created,—the air blast is created by a turbofan engine supplied with ambient air and comprising a stream of secondary compressed air located around a central body supplied with primary compressed air and a blower driven by an engine or a turboshaft engine integrated into said central body,—compressed air is tapped in said stream of secondary air in order to supply one or several pre-mixing chambers further supplied with said fluid to be sprayed in such a way as to spray this fluid with tapped compressed air, before diffusing said mixture to the exterior.

According to a further embodiment of the method, the compressed air can be tapped in said stream of secondary air and is supplied with fluid to be sprayed by arranging said pre-mixing chamber or chambers as satellites around a fairing enclosing the stream of secondary air.

### BRIEF DESCRIPTION OF THE DRAWINGS

The annexed drawings show the invention:

FIG. 1 shows as a cross-section and flat, the complete assembly of the device according to various embodiments. Here can be found the essential items which are: the central body 2, the blower (or low-pressure compressor) 1, the flow straighteners 3, the fairing 4, the aerodynamic stream 5, a pre-mixing chamber 7 with its inlet nozzle for tapping air 8 and its ejection cone 12.

FIG. 2 shows as a cross-section and in space and in detail the device of an aerodynamic injector with its ejector and its swirler placed in a pre-mixing chamber, 7. This figure details and makes it possible to show the principle of shearing and of mixing, which causes the movement of the compressed air which escapes to the free air, around the spraying of the fluid created by the ejector.

FIG. 3 shows as a cross-section and in space an embodiment using a turbofan engine. The secondary stream of a turbofan engine shows the ideal stream in overpressure in order to install at the outlet, the pre-mixing chambers provided with their cones which tap a portion of the flow of the secondary stream and eject the sprayed and pre-mixed fluid into the blast resulting from the main flow of the secondary stream.

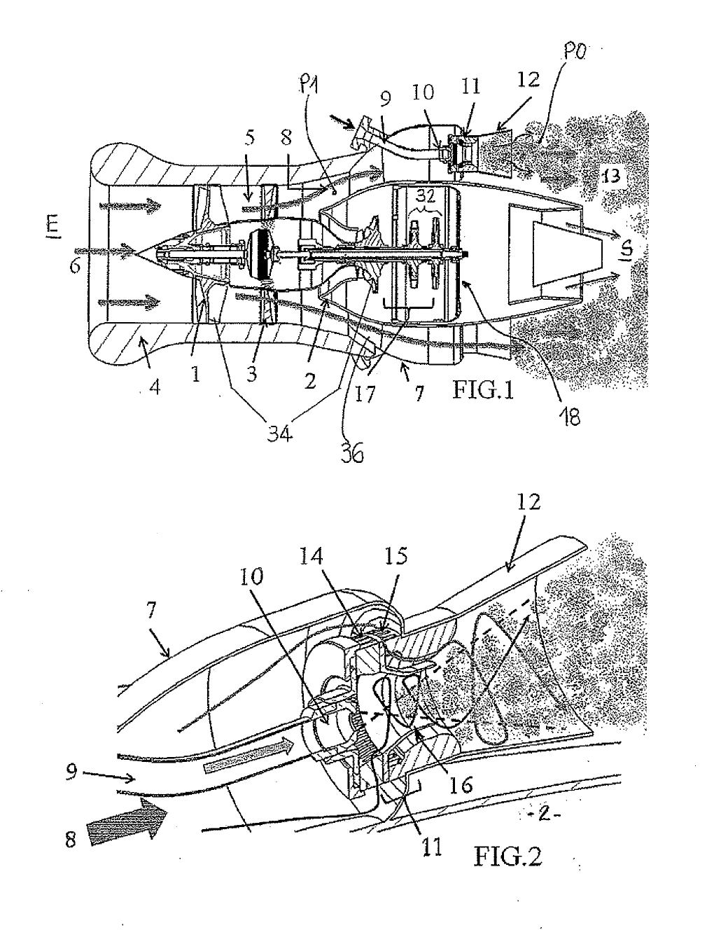

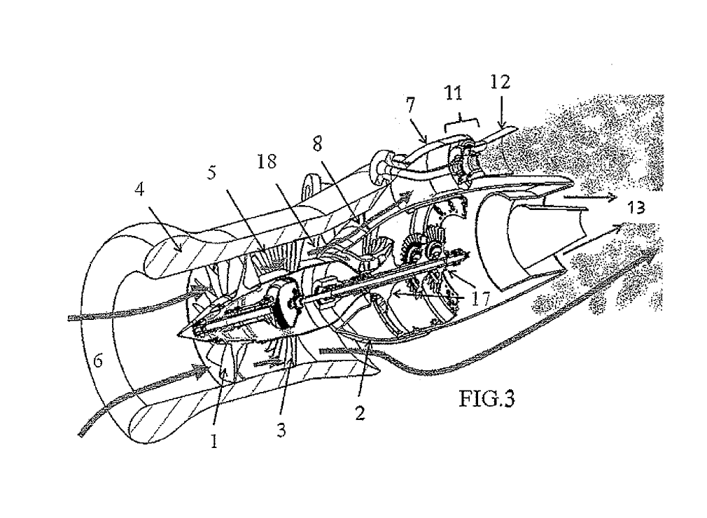

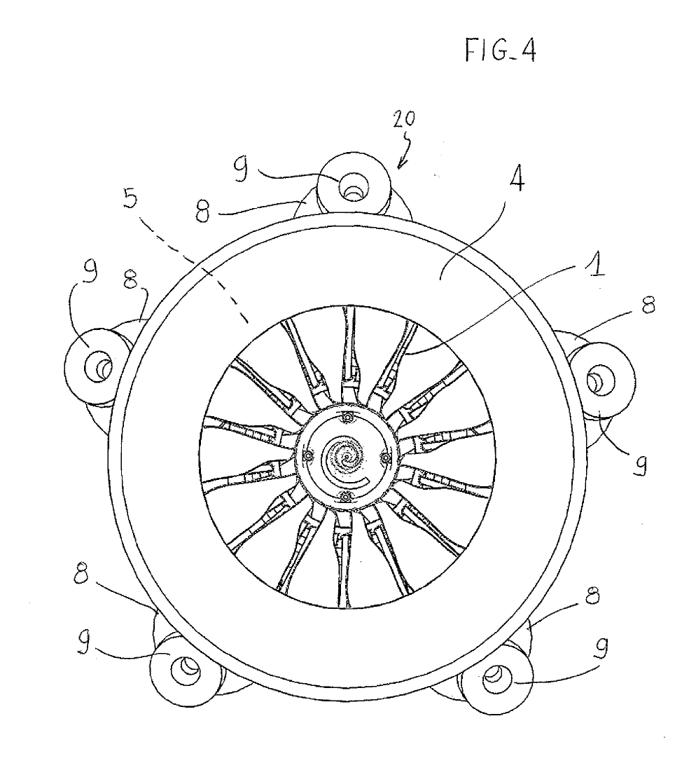

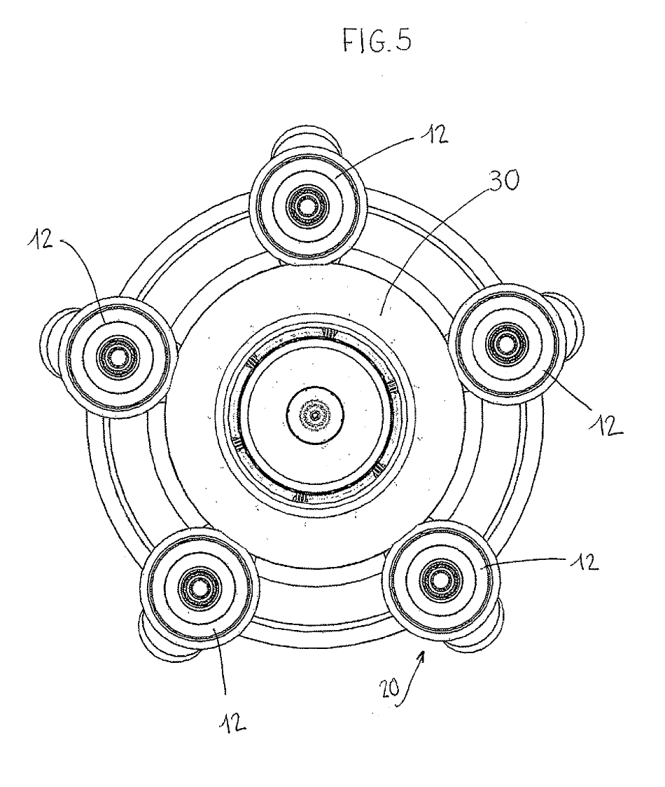

### DETAILED DESCRIPTION

The device, according to various embodiments, makes it possible to respond to the various objectives sought which bring to the prior art of spraying fluids using the air blast effect, a substantial improvement.

To this effect, a high-rate compressed air flow generator is provided, supplied with ambient air and comprising a blower driven by an engine or a turboshaft engine integrated into a central body supplied with primary compressed air, and a fairing creating an aerodynamic stream of secondary compressed air around the central body.

At least one compressed air tapping nozzle is provided connected to the stream of secondary air.

And it is advised that the supply in fluid to be sprayed be connected to a source of a fluid intended for civil protection, for the protection or the decontamination of the environment, or for agriculture. A fluid for agriculture will be a fluid that is useful in this field, such as of the fertilizer, weed-killer, phytosanitary type.

An engine comprising a stream of secondary air around a stream of primary air and provided with such a device for spraying a fluid is also related.

Also related is a turbofan engine supplied with ambient air and comprising a stream of compressed secondary air located around a central body supplied with primary compressed air and a blower driven by an engine or a turboshaft engine integrated into said central body, this reactor being provided with a device for spraying a fluid to be sprayed using the air blast effect, this device being itself provided with one or several pre-mixing chambers comprising a compressed air tapping nozzle connected to said stream of secondary air and supplied with said fluid to be sprayed in such a way as to spray and pre-mix this fluid with the tapped compressed air, before diffusing the mixture to the exterior, through ejection cones, using the air blast effect.

Also related is a method for spraying a fluid, wherein:
the air blast is created by a turbofan engine,
and compressed air is tapped in its stream of secondary air in order to supply one or several pre-mixing chambers further supplied with said fluid to be sprayed, in such a way as to spray this fluid with the tapped compressed air, before diffusing said mixture to the exterior.

Favorably, and as shown, the low-pressure airflow generator supplied with ambient air 6, which has for function to create a high-flow-rate compressed air blast in an aerodynamic stream, will comprise the blower 1 rotating at high speed by the effect of the engine or turboshaft engine 17 integrated into the central body 2 and associated to fixed or mobile flow straighteners 3 which are intended to provide an evacuation of the flow of air without gyration and an exterior peripheral fairing 4 creating an aerodynamic stream 5 in relation to the central body 2.

It is advised that this airflow generator be dimensioned in such a way that in nominal operation, the pressure of the air at the outlet of the pressurized stream 5 of secondary air, created by the rotation of the blower, be at least greater by 15% than the inlet pressure in 6 (which is the atmospheric pressure of the air in the operating conditions).

In particular on such an airflow generator, various embodiments propose to assemble a device 20 for spraying a fluid by the effect of the gaseous blast created.

As shown in FIG. 6, the supply 9 in fluid to be sprayed will be connected to a source 21 of a fluid intended for civil protection, for the protection or the decontamination of the environment, or for agriculture. In order to spray this fluid, the device 20 comprises at least one nozzle 8 for tapping compressed air connected to the stream of secondary air 5 of the airflow generator.

As such, one or several pre-mixing chamber 7 shall be arranged towards the outlet of the aerodynamic stream with for function to provide the spraying and the air/fluid pre-mixture. Each chamber is supplied with compressed air by tapping (in 8) of the flow using a nozzle placed in and towards the outlet of the aerodynamic stream 5.

It is recommended that the/each chamber be overpressurized in relation to the outside ambient air by at least 15%, in nominal operation.

Each chamber, according to another characteristic, is supplied with fluid by a conduit 9 at the end of which is fixed an ejector making a restriction (10) which exits into an aerodynamic swirler 11 intended to supplement the spraying of the fluid and to provide for the mixing of the tapping air with the fluid sprayed by the ejector in such a way that the mixture is ejected by a cone 12 which exits into the free air in the blast of air 13.

The properties are known of aerodynamic swirlers 11 which have for function to supplement the spraying of the fluid provided firstly hydro-mechanically by the ejector 10 due to the pressure which is applied to the fluid in the conduit 9.

The operating principle is based on the effect of the compressed air contained in the chamber 7 which is tapped by a nozzle in the aerodynamic stream 8 and which is evacuated towards the exterior by passing by two annular conduits with directed slots 14 and 15. The first causing to rotate a portion of the air in one direction around the fluid sprayed and the second causing to rotate the rest of the air in the other direction around a venturi 16. The masses of air placed into contrary movement, around the fluid sprayed by the ejector, have two conjugated effects: a shearing effect which further breaks the droplets and refines them and an aerodynamic effect which creates in the ejection cone (12) an air/fluid pre-mixture which will further favor the final mixture.

As the pre-mixing chambers are supplied by nozzles which carry out a tapping of air towards the outlet of the aerodynamic stream, one of the characteristics according to various embodiments is to arrange that the airflow generator in the aerodynamic stream provide a performing pressure, which must favorably be at least 15% greater than the outside pressure of the ambient air in nominal operation.

Due to the assembly described, a characteristic according to various embodiments, is that of being able to obtain, at a given pressure of the aerodynamic stream, finer droplets than those usually obtained in a traditional assembly with the pressure of the fluid generally applied or inversely in the same conditions of pressure of the aerodynamic stream, to obtain the size of usual droplets with a fluid at a pressure that is much lower than the pressure generally applied therefore requiring less hydraulic power in order to achieve this.

Another characteristic, according to various embodiments, is to favor the final mixture substantially thus making it possible for the blast effect to carry more intimately and farther the droplets of fluid.

The difficulty in realizing the device, according to various embodiments, resides especially in the capacity of providing in the aerodynamic stream, a sufficient pressure and a good directivity of an airflow of high rate, for the proper operation of the pre-mixing chambers which are supplied with compressed air by tapping at the outlet of the stream.

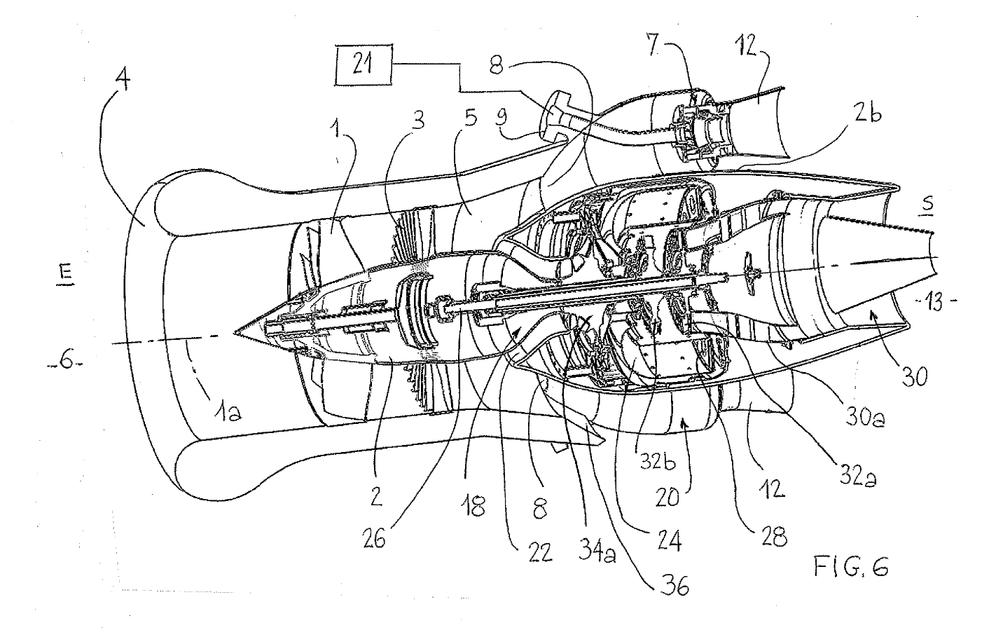

In an embodiment according to FIG. 3, the low-pressure air generator uses the traditional architecture of a turbofan engine and is constituted of a central body 2 which supports a hull 4 as such creating an aerodynamic stream that is carefully designed and dimensioned in compliance with Aerodynamic rules 5. In the central body, at the rear portion 17 is installed a turboshaft engine. This turboshaft engine is connected by the mechanical devices to a blower 1 placed at the front portion of the central body, which comprises blades of adapted aerodynamic form and which rotate at high speed in the general axis of the whole. The air blast created by the rotation of the blower is called the main flow. Due to the laws of Thermodynamics, the main flow at the outlet of the blower is brought to a pressure that is greater than the air inlet pressure 6, which is at atmospheric pressure, by a minimum of 15% and undergoes an increase in temperature of a few tens of degrees in relation to the inlet temperature.

Downstream of the blower and at an adapted distance, is arranged a fixed or mobile slat grille in the main stream 3, these slats have aerodynamic profiles that are carefully adapted and have a function of flow straightener. The main flow at the outlet of the blower has indeed, a movement of gyration in the axis of the stream that has to be counteracted. The grille of the straighteners has the effect of returning the main flow in the axis of the stream, as such providing a directive and laminar air blast, without damaging too much the pressure or the general speed of the main flow produced by the blower.

Downstream of the straighteners is arranged, in the central body, an annular air inlet which takes a portion of the main air flow in order to supply the operation of the Turboshaft engine 18, the air which is directed into this air inlet is called primary air. The remaining air is directed towards the ejection and is called secondary air and the stream which carries it is called secondary stream, it generally represents 40 to 80% of the main flow and is ejected at speeds of a magnitude of 150 to 250 m/s.

The conditions which are established in the secondary stream, at nominal speed, in terms of total pressure of the flux, temperature and directivity, are those that are suited to the proper operation of the pre-mixing chambers. In the embodiment, the tapping nozzles of pre-mixing chambers are arranged in the secondary flow straight and at the outlet of the stream 8, in such a way that they do not hinder the ejection of the residual secondary flow, which can represent up to 80% of the total of the secondary flow and which constitutes once ejected to the free air the air blast which dilutes and diffuses the droplets of fluid.

Consequently, in the embodiment, one shall strive to arrange the ejection cones of the pre-mixing chambers 12 in the residual secondary flow.

Finally, the exhaust gases of the turboshaft engine will be ejected by a pipe located at the rear portion of the central body, concentric and at the core of the residual secondary flow 19. Experience shows that these gases very quickly lose their speed and especially their temperature and although they only represent less than 30% of the mass of the ejected air, they will not significantly damage the distribution of the droplets carried by the air blast but will favor however the general speed of the air blast and will improve the carrying distance.

The device, according to various embodiments, is particularly intended to applications in the field of civil protection, but also of protection for the environment and for agriculture.

As understood, a notable portion of various embodiments is based:
on the arrangement of the mixing chambers 7/12 at the outlet of the secondary stream 5/8 of a turbofan engine,
and on the use of the difference in pressure between the tapping pressure (P1 FIG. 1) and the ambient pressure (PO FIG. 1 and which is that of the outside air at the outlet of the end 12) in order to realize a pre-mixing of the fluid 20 that is to be sprayed with a portion of the secondary air tapped via the nozzle or nozzles 8.

For this, the swirlers 11 placed at the inlet of the mixing chamber 7/12 make it possible to shear the fluid sprayed in order to create very fine drops of fluid to be sprayed and to carry out an intimate mix between this fluid and the air, before spraying this mixture into the main air flow 13.

As such, the fluid to be sprayed (water for example) will be injected in two steps: the first step provides a fine shearing of the drops and their intimate mixing with the tapping air, which has for effect, in a second step, to render particularly effective the distribution of these drops in intimate mix with the air in the main flow.

In this way, in particular in fire-fighting applications, it will be possible to sharply reduce the size of the sprayed drops. The finer the drops are, the higher the extinguishing effectiveness of the fire is (inerting).

FIGS. 3, 4 show that several secondary air tapping nozzles 8 are favorably distributed circumferentially in the annular stream of secondary compressed air 5.

As such, several devices for spraying fluid, here all marked 20, can be connected to the peripheral stream of secondary air 5.

A single stage, therefore following a single crown will a priori be sufficient; see FIGS. 3 and 4.

Furthermore, the supply 9 of the/each tapping nozzle 8 is connected to a source 21 of fluid to be sprayed.

A common source is possible. It is understood that the source 21 will contain an appropriate quantity of fluid intended for civil protection, the protection or the decontamination of the environment, or for agriculture.

Between three and seven spraying devices 20 will be favorably arranged around the fairing 4 (an arrangement with five such devices angularly distributed in a regular manner is shown in FIGS. 4 and 5).

As to the interior of the central body 2, in particular FIG. 6 makes it possible to show that it comprises the means that are typically useful for the operation of the engine or turboshaft engine 18 with a blower.

First of all, this central body is interiorly supplied with compressed air by tapping in 22 in order to channel a flow of primary air towards the annular central combustion zone 24.

Several tappings 22 are provided, downstream of the straighteners 3, in place in the stream 5.

In the central body 2, can be seen in particular, around the engine shaft 26, the fuel inlets 28.

These inlets supply towards the injectors the fuel that, with the primary fuel air, will make it possible to ignite the mixture created, in the combustion zone 24.

The burned gases are evacuated downstream, by the central pipe 30. They participate in creating the gaseous flow 13.

The central drive shaft 26 connects the rotating blower 1, located upstream, to the turbine portion 32, located further downstream (always in relation with the overall direction of flow of the air between the inlet E and the outlet S) with, between the two, the air compressor portion 34 located upstream of the combustion zone.

The portions 32, 34 include several stages respectively of turbines and of compressors.

Typically, are found high pressure (32a, 34a) and respectively low pressure 32b, 1 stages of turbines and of compressors.

In FIG. 6 in particular is marked 36 the annular outlet of the flow of secondary air, i.e. the rear end of the fairing 4.

It is observed that, along the central axis la, of this machine 1, the central body 2 as well as the pre-mixing chambers 7 and their pipes or cones 12 extend until downstream of the outlet 36, therefore father behind. However, these cones 12 will be located favorably around the upstream portion 30a of the pipe 30, therefore around the bulged rear portion 2b of the peripheral wall of the central body 2.

In various figures, it will also have been noticed that the device for spraying a fluid 20 comprises one or several satellites. Each of them encloses the said pre-mixing chamber or chambers 7 and is arranged around the fairing 4 of the stream 5 of secondary air.

Of course, each pre-mixing chamber 7 is continued in the rear by the diffuser 12.

In light of the preceding, it will have further been understood that various embodiments are also characteristic in that it relates to a method for spraying a fluid, wherein this fluid is mixed with compressed air, before diffusing the mixture using the air blast effect created with for particularities that:
the air blast is created by a turbofan engine supplied with ambient air 6 and comprising a stream 5 of secondary compressed air,
compressed air is tapped in said stream of secondary air 5 in order to supply one or several pre-mixing chamber 7 further supplied with said fluid to be sprayed 9 in such a way as to spray this fluid with the tapped compressed air, before diffusing said mixture towards the exterior.

Precisely, the compressed air will more preferably be tapped in said stream of secondary air 5 and supplied the device with fluid to be sprayed 9 by therefore arranging said pre-mixing chamber or chambers 7 as satellite(s) around the fairing 4.

And recall that the device, according to various embodiments, shall find utility, in particular, in fire-fighting applications in order to extinguish the fire but also to protect or cool, in applications to protect the environment for actions of protecting or decontaminating or very simply in agricultural applications for wetting or the spreading of phytosanitary products.

What is claimed is:

1. A device for spraying a fluid using an air blast effect arranged on a high-rate compressed air flow generator, supplied with ambient air and comprising a blower driven by an engine or a turboshaft engine integrated into a central body supplied with primary compressed air, fixed or mobile flow straighteners placed downstream of the blower, a fairing creating an aerodynamic stream of secondary compressed air around the central body, the device comprising one or several pre-mixing chambers receiving the fluid to be sprayed, via a supply in fluid, spraying and pre-mixing this fluid before diffusing it through cones using the air blast effect,
wherein the device comprises at least one nozzle for tapping compressed air connected to the stream of secondary air.

2. The device, according to claim 1, wherein the supply in fluid to be sprayed is connected to a source of a fluid intended for civil protection, the protection or the decontamination of the environment, or for agriculture.

3. The device, according to claim 1, wherein the device for spraying a fluid and the airflow generator are designed and dimensioned in such a way that the flow of secondary compressed air, created in the aerodynamic stream by the rotation of the blower, is in overpressure in relation to the outside ambient air by at least 15% in nominal operation.

4. The device, according to claim 3, wherein the device comprises several nozzles for tapping air arranged in the flow of the aerodynamic stream of secondary compressed air, at the outlet of this stream, in such a way that the pre-mixing chamber or chambers are supplied with secondary compressed air at a pressure that is at least greater by 15% than the outside ambient air.

5. The device, according to claim 1 or 2, characterized by thc fact thatwherein each pre-mixing chamber is provided with a supply conduit of the fluid to be sprayed of which the outlet orifice carries an ejector, which exits into an aerodynamic swirler arranged at the bottom of the chamber of which the function is to supplement the spraying of the ejector by aerodynamic shearing and to provide an air/fluid pre-mixture before ejecting it into the free air, in the blast of air.

6. The device, according to claim 5, wherein the pre-mixture is ejected after a venturi which exits into the free air in the blast of air.

7. The device, according to claim 6, wherein the device comprises two annular conduits with directed slots receiving the secondary air, one causing to rotate a portion of this air in one direction, around the fluid sprayed, the other causing to rotate the rest of the air in the other direction around the venturi.

8. The device, according to claim 1, comprising several ejection cones in the secondary residual airflow of several pre-mixing chambers.

9. The device, according to claim 1, comprising several nozzles for tapping of several pre-mixing chamber arranged, in the secondary airflow, straight and at the outlet of the stream, in such a way that they do not hinder the ejection of the residual secondary flow, which can represent up to 80% of the total of the flux of secondary air, and which constitutes, once ejected into the free air, the air blast which dilutes and which diffuses the droplets of the fluid diffused.

10. An engine comprising a stream of secondary air around a stream of primary air, comprising the device for spraying a fluid according to claim 1, by constituting said high-rate compressed air flow generator at the stream of secondary air to which is/are connected the nozzle or nozzles for tapping compressed air.

11. The engine according to claim 10, wherein the engine is a turbofan engine.

12. The engine according to claim 9, wherein the device for spraying a fluid comprises one or several satellites enclosing said pre-mixing chamber or chambers and arranged around the fairing of the stream of secondary air.

13. A turbofan engine supplied with ambient air and comprising a stream of secondary compressed air located around a central body supplied with primary compressed air and a blower driven by an engine or a turboshaft engine integrated into said central body, comprising a device for spraying a fluid to be sprayed using the air blast effect, the device being provided with one or several pre-mixing chambers comprising a compressed air tapping nozzle connected to said stream of secondary air and supplied with said fluid to be sprayed in such a way as to spray and pre-mix this fluid with the tapped compressed air, before distributing the mixture to the exterior, through ejection cones, using the air blast effect created.

14. A method for spraying a fluid, wherein this fluid is mixed with compressed air, before diffusing the mixture using the air blast effect created, wherein:
the air blast is created by a turbofan engine supplied with ambient air and comprising a stream of secondary compressed air located around a central body supplied with primary compressed air and a blower driven by an engine or a turboshaft engine integrated into said central body,
compressed air is tapped in said stream of secondary air in order to supply one or several pre-mixing chambers further supplied with said fluid to be sprayed in such a way as to spray this fluid with tapped compressed air, before diffusing said mixture to the exterior.

15. The method according to claim 14, wherein the compressed air is tapped in said stream of secondary air and is supplied with fluid to be sprayed by arranging said pre-mixing chamber or chambers as satellites around a fairing enclosing the stream of secondary air.

16. The engine, according to claim 10, wherein the supply in fluid to be sprayed is connected to a source of a fluid intended for civil protection, the protection or the decontamination of the environment, or for agriculture.

17. The engine, according to claim 10, wherein the device for spraying a fluid and the airflow generator are designed and dimensioned in such a way that the flow of secondary compressed air, created in the aerodynamic stream by the rotation of the blower, is in overpressure in relation to the outside ambient air by at least 15% in nominal operation.

18. The engine, according to claim 17, wherein the device comprises several nozzles for tapping air arranged in the flow of the aerodynamic stream of secondary compressed air, at the outlet of this stream, in such a way that the pre-mixing chamber or chambers are supplied with secondary compressed air at a pressure that is at least greater by 15% than the outside ambient air.

19. The device, according to claim 2, wherein the device for spraying a fluid and the airflow generator are designed and dimensioned in such a way that the flow of secondary compressed air, created in the aerodynamic stream by the rotation of the blower, is in overpressure in relation to the outside ambient air by at least 15% in nominal operation, and the device comprises several nozzles for tapping air arranged in the flow of the aerodynamic stream of secondary compressed air, at the outlet of this stream, in such a way that the pre-mixing chamber or chambers are supplied with secondary compressed air at a pressure that is at least greater by 15% than the outside ambient air.

20. The device, according to claim 2, wherein each pre-mixing chamber is provided with a supply conduit of the fluid to be sprayed of which the outlet orifice carries an ejector, which exits into an aerodynamic swirler arranged at the bottom of the chamber of which the function is to supplement the spraying of the ejector by aerodynamic shearing and to provide an air/fluid pre-mixture before ejecting it into the free air, in the blast of air, and wherein the pre-mixture is ejected after a venturi which exits into the free air in the blast of air.
